(19) United States
(12) Patent Application Publication
(10) Pub. No.: US 2025/0071840 A1
(43) Pub. Date: Feb. 27, 2025

(54) COMMUNICATION CONTROL APPARATUS AND METHOD FOR VEHICLE

(71) Applicants: Hyundai Motor Company, Seoul (KR); Kia Corporation, Seoul (KR)

(72) Inventors: Sang Min Lee, Suwon (KR); Eul Yong Kim, Hwaseong (KR)

(21) Appl. No.: 18/439,328

(22) Filed: Feb. 12, 2024

(30) Foreign Application Priority Data
Aug. 24, 2023 (KR) 10-2023-0111402

(51) Int. Cl. H04W 76/18; H04W 48/16; H04W 76/30

(52) U.S. Cl. CPC H04W 76/18; H04W 48/16; H04W 76/30

(57) ABSTRACT

A communication control apparatus for a vehicle includes a communication device, a memory, and a controller. The communication control apparatus boots the communication device in response to a vehicle being turned on, identifies a specified operator corresponding to a current position of the vehicle based on operator list information stored in the memory, attempts a connection with a communication network provided by the specified operator, through the communication device, operates and releases a specified operation mode for stopping an operation of the communication device, when receiving a signal including a specified code, after being connected with the communication network, and transmits update information including a communication state of the communication network to a server, when the specified operation mode is released.

### CROSS-REFERENCE TO RELATED APPLICATION

This application claims under 35 U.S.C. § 119(a) the benefit of Korean Patent Application No. 10-2023-0111402, filed in the Korean Intellectual Property Office on Aug. 24, 2023, the entire contents of which are incorporated herein by reference.

### BACKGROUND

### (a) Technical Field

The present disclosure relates to a communication control apparatus and method for a vehicle, more particularly, to the communication control apparatus and method that utilize a communication device of the vehicle to perform a connection with a specified communication network under various environments.

### (b) Description of the Related Art

With the development of vehicle technology, components mounted on a vehicle can be used to provide services and/or convenience features to a user. For example, the user may receive a service based on data received from the outside through a communication device mounted on the vehicle.

Meanwhile, when a vehicle travels across a border or when a vehicle control apparatus attempts a communication network connection with a base station again as an abnormality occurs in the communication network connection, the vehicle control apparatus may re-connect to the communication network connection again according to various algorithms.

For example, when power is applied to the vehicle, the vehicle control apparatus may boot a communication device (e.g., a modem device) loaded on the vehicle and may perform a network search function based on specified information (e.g., a public land mobile network (PLMN) list). Thereafter, when an abnormality occurs in the connected network, the vehicle control apparatus may search for another network by using the specified information again.

For example, when the vehicle crosses an international border while driving, there may occur a situation of having to perform another network connection as a network connection in an existing country is disconnected. To this end, the vehicle control apparatus may provide a function of searching for another network based on information about a service provider (e.g., a communication company) in a new country and performing a communication network connection.

However, as a process of resetting the communication device is required in the process of attempting the communication network connection again, there may occur a situation in which the user does not receive a required service during a time taken in such a process. For example, in a situation where an emergency call (e.g., eCall) function is required, the user may fail to receive the function due to the process of resetting the communication device.

In addition, when the communication network connection is performed based on a type (e.g., 2nd generation (2G)) in which it is relatively poor in a driving environment, such as Europe, in which movement between countries is easily performed, although the vehicle enters a new country, a communication network connection based on a satisfactory type (e.g., 3rd generation (3G), 4th generation (4G), and/or 5th generation (5G)) provided by service providers in the new country is not performed until the communication network connection of the poor type, which is connected in the existing country, is lost.

### SUMMARY

An aspect of the present disclosure provides a communication control apparatus for continuously monitoring whether the connection is lost because a network electric field is weak, when an abnormality occurs in the connected communication network, and attempting a connection based on another communication network using information (e.g., operator list information) stored in a memory.

Another aspect of the present disclosure provides a communication control apparatus for continuously monitoring whether the connection is lost because a network electric field is weak, when an abnormality occurs in the connected communication network, and temporarily operating and releasing a specified operation mode (e.g., an airplane mode) for stopping the operation of a communication device when receiving a signal including a specified code (e.g., a reject code and/or a detach code) while continuously performing communication when the connection is not lost.

Another aspect of the present disclosure provides a communication control apparatus for transmitting update information including a communication state of a communication network to a server, when a specified operation mode is released.

Another aspect of the present disclosure provides a communication control apparatus for receiving updated operator list information based on a specified period from a server, identifying a priority of an operator (or a service provider) which provides a communication network based on the received information, and performing a communication network connection through a communication device based on the priority.

Another aspect of the present disclosure provides a communication control apparatus for identifying whether a communication network connection type is degraded, when identifying a situation in which a host communication crosses a border, temporarily operating and releasing a specified operation mode (e.g., an airplane mode) for stopping the operation of a communication device and transmitting update information including a communication state of a communication network, when identifying a situation in which the communication is performed based on the degraded communication network connection, and attempting a connection based on another communication network using information stored in a memory.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a communication control apparatus for a vehicle may include a communication device, a memory storing at least one instruction, and a controller operatively connected with the communication device and the memory. For example, the at least one instruction may be configured to, when executed by the controller, cause the communication control apparatus to boot the communication device in response to the vehicle being turned on, identify a specified operator corresponding to a current position of the vehicle based on operator list information stored in the memory, attempt a connection with a communication network provided by the specified operator, through the communication device, operate and release a specified operation mode for stopping an operation of the communication device, when receiving a signal including a specified code, after being connected with the communication network, and transmit update information including a communication state of the communication network to a server, when the specified operation mode is released.

According to an embodiment, the at least one instruction may be configured to, when executed by the controller, cause the communication control apparatus to monitor whether the communication network is abnormal based on a connection, when normally connected with the communication network, identify whether the connection is disconnected, when identifying that an abnormality occurs in the communication network, and attempt a connection with a sub-communication network provided by a sub-operator of the specified operator corresponding to the current position, based on the operator list information, when the connection is lost.

According to an embodiment, the at least one instruction may be configured to, when executed by the controller, cause the communication control apparatus to continuously perform communication based on the connection, based on the connection is not lost.

According to an embodiment, the specified code may include at least one of a reject code or a detach code, or any combination thereof.

According to an embodiment, the at least one instruction may be configured to, when executed by the controller, cause the communication control apparatus to continuously monitor whether a type of the connection changes, when identifying that the vehicle travels from a specified section to another section, after being connected with the communication network, operate and release the specified operation mode, when identifying that the type changes, and attempt a connection with a sub-communication network corresponding to the other section, the sub-communication network being provided by a sub-operator of the specified operator, based on the operator list information.

According to an embodiment, the at least one instruction may be configured to, when executed by the controller, cause the communication control apparatus to identify that the vehicle travels from the specified section to the other section, when it is identified that the vehicle crosses a border based on navigation information.

According to an embodiment, the at least one instruction may be configured to, when executed by the controller, cause the communication control apparatus to operate and release the operation mode, when identifying that the type changes to a second type including 2nd generation (2G), while performing the connection in a first type based on at least one of 3rd generation (3G), 4th generation (4G), or 5th generation (5G), or any combination thereof.

According to an embodiment, the at least one instruction may be configured to, when executed by the controller, cause the communication control apparatus to release the specified operation mode and transmit the update information including the communication state of the communication network in the other section to the server.

According to an embodiment, the at least one instruction may be configured to, when executed by the controller, cause the communication control apparatus to receive updated operator list information including the update information based on a specified period from the server and store the updated operator list information in the memory.

According to an embodiment, the specified operation mode may include an airplane mode.

A vehicle may include the communication control apparatus.

According to another aspect of the present disclosure, a communication control method for a vehicle may include booting, by a controller, a communication device in response to the vehicle being turned on, identifying, by the controller, a specified operator corresponding to a current position of the vehicle based on operator list information stored in a memory, attempting, by the controller, a connection with a communication network provided by the specified operator, through the communication device, operating and releasing, by the controller, a specified operation mode for stopping an operation of the communication device, when receiving a signal including a specified code, after being connected with the communication network, and transmitting, by the controller, update information including a communication state of the communication network to a server, when the specified operation mode is released.

According to an embodiment, the communication control method may further include monitoring, by the controller, whether the communication network is abnormal based on a connection, when normally connected with the communication network, identifying whether the connection is disconnected, when identifying that an abnormality occurs in the communication network, and attempting a connection with a sub-communication network provided by a sub-operator of the specified operator corresponding to the current position, based on the operator list information, when the connection is lost.

According to an embodiment, the communication control method may further include continuously performing, by the controller, communication based on the connection, based on the connection is not lost.

According to an embodiment, the specified code may include at least one of a reject code or a detach code, or any combination thereof.

According to an embodiment, the communication control method may further include continuously monitoring, by the controller, whether a type of the connection changes, when identifying that the vehicle travels from a specified section to another section, after being connected with the communication network, operating and releasing, by the controller, the specified operation mode, when identifying that the type changes, and attempting, by the controller a connection with a sub-communication network corresponding to the other section, the sub-communication network being provided by a sub-operator of the specified operator, based on the operator list information.

According to an embodiment, the continuous monitoring of whether the type of the connection changes, when identifying that the vehicle travels from the specified section to the other section, after being connected with the communication network, by the controller may include identifying, by the controller, that the vehicle travels from the specified section to the other section, when it is identified that the vehicle crosses a border based on navigation information.

According to an embodiment, the operating and releasing of the specified operation mode, when identifying that the type changes signal, by the controller may include operating and releasing, by the controller, the operation mode, when identifying that the type changes to a second type including 2G, while performing the connection in a first type based on at least one of 3G, 4G, or 5G, or any combination thereof.

According to an embodiment, the communication control method may further include releasing, by the controller, the operation mode and transmitting, by the controller, the update information including the communication state of the communication network in the other section to the server.

According to an embodiment, the communication control method may further include receiving, by the controller, updated operator list information including the update information based on a specified period from the server and storing, by the controller, the updated operator list information in the memory.

According to an embodiment, the specified operation mode may include an airplane mode.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating components of a communication control apparatus for a vehicle according to an embodiment of the present disclosure;

FIG. 2 is a flowchart of a communication control method for a vehicle according to an embodiment of the present disclosure;

FIG. 3 is a flowchart of a communication control method according to an embodiment of the present disclosure;

FIG. 4 is a flowchart of a communication control method according to an embodiment of the present disclosure;

FIG. 5 is a flowchart of a communication control method according to an embodiment of the present disclosure; and

FIG. 6 illustrates a computing system about a communication control method according to an embodiment of the present disclosure.

With regard to description of drawings, the same or similar denotations may be used for the same or similar components.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, some embodiments of the present disclosure will be described in detail with reference to the exemplary drawings. In the drawings, the same reference numerals will be used throughout to designate the same or equivalent components. In addition, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are only used to distinguish one element from another element, but do not limit the corresponding elements irrespective of the order or priority of the corresponding elements. Furthermore, unless otherwise defined, all terms including technical and scientific terms used herein are to be interpreted as is customary in the art to which this invention belongs. It will be understood that terms used herein should be interpreted as having a meaning that is consistent with their meaning in the context of this disclosure and the relevant art and will not be interpreted in an idealized or overly formal sense unless expressly so defined herein.

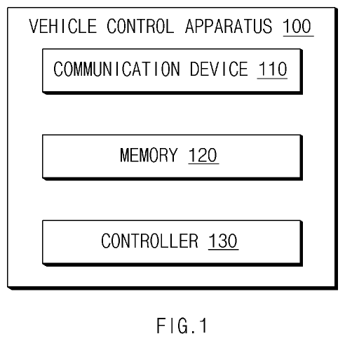

Hereinafter, embodiments of the present disclosure will be described in detail with reference to FIGS. 1 to 6.

FIG. 1 is a block diagram illustrating components of a communication control apparatus for a vehicle according to an embodiment of the present disclosure.

According to an embodiment, a communication control apparatus (or vehicle control apparatus) 100 may include at least one of a communication device 110, a memory 120, or a controller 130, or any combination thereof. The components of the vehicle control apparatus 100, which are shown in FIG. 1, are illustrative, and embodiments of the present disclosure are not limited thereto. For example, the vehicle control apparatus 100 may further include components (e.g., at least one of an interface, a sensor device, a display, or a driving device, or any combination thereof) which are not shown in FIG. 1.

According to an embodiment, the communication device 110 may assist in establishing a communication channel (e.g., a wireless communication channel) between the vehicle control apparatus 100 and an external device (e.g., a server) and communicating over the established communication channel. For example, the communication device 110 may include one or more communication processors which operate independently of the controller 130 (e.g., an application processor) and support direct (e.g., wired) communication or wireless communication.

For example, the communication device 110 may include a wireless communication module (e.g., a cellular communication module, a short range wireless communication module, or a global navigation satellite system (GNSS) communication module) or a wired communication module (e.g., a local area network (LAN) communication module or a power line communication module). The corresponding communication module among such communication modules may communicate with the external device over a first network (e.g., a short range communication network such as Bluetooth, wireless-fidelity (Wi-Fi) Direct, or infrared data association (IrDA)) or a second network (e.g., a long range communication network such as a legacy cellular network, a fifth generation (5G) network, a next-generation communication network, the Internet, or a computer network (e.g., a local area network (LAN) or a wide area network (WAN))). Such several types of communication modules may be integrated into one component (e.g., a single chip) or may be implemented as a plurality of components (e.g., a plurality of chips) independent of each other. Furthermore, the communication device 110 and the controller 130 may be implemented as a single chip.

For example, the communication device 110 may be connected with communication networks corresponding to base stations of various operators (or service providers) (e.g., communication companies) to transmit and receive various types of data.

For example, when a vehicle (also referred to herein as a “host vehicle”) is turned on, the communication device 110 may be booted by control of the controller 130.

For example, the communication device 110 may attempt a connection with a communication network provided by a specified operator. The specified operator may include an operator identified as having the highest priority based on operator list information (e.g., public land mobile network (PLMN) list information).

As an example, the operator list information may include at least one of at least one mobile country code (MCC), a mobile network code (MNC), at least one PLMN code for testing, or a network identification number of each of operators, or any combination thereof. The controller 130 may identify a unique identification number of a network provided by a base station of the operator, based on the operator list information, and may attempt a communication connection through the communication device 110 based on the unique identification number.

For example, the communication device 110 may operate in a specified operation mode (e.g., an airplane mode) for stopping a communication operation, based on control of the controller 130.

According to an embodiment, the memory 120 may store a command or data. For example, the memory 120 may store one or more instructions, when executed by the controller 130, causing the vehicle control apparatus 100 to perform various operations.

For example, the memory 120 and the controller 130 may be implemented as one chipset. The controller 130 may include at least one of a communication processor or a modem.

For example, the memory 120 may store the operator list information. The memory 120 may store, for example, an updated operator list information received based on a specified period from the outside (e.g., a server).

According to an embodiment, the controller 130 may be operatively connected with the communication device 110 and/or the memory 120. For example, the controller 130 may control operations of the communication device 110 and/or the memory 120.

For example, the controller 130 may boot the communication device 110 in response to that the host vehicle is turned on.

As an example, when the host vehicle is turned on, the controller 130 may turn on a power source (or operation) of the communication device 110 to activate a data transmission and reception function through the communication device 110.

For example, the controller 130 may identify a specified operator corresponding to a current position of the host vehicle based on the operator list information stored in the memory 120.

As an example, the controller 130 may identify an operator which provides a communication network at a position where the host vehicle is currently present for the communication network connection through the communication device 110.

As an example, the controller 130 may identify a specified operator with the highest priority among a plurality of operators corresponding to the current position, based on the operator list information. The priority may be data predefined by a producer of the host vehicle.

For example, the controller 130 may attempt a connection with the communication network provided by the specified operator through the communication device 110.

As an example, the controller 130 may attempt a connection with a communication network provided by a base station of the specified operator through the communication device 110.

As an example, when normally connected with the communication network, the controller 130 may continuously monitor whether the communication network is abnormal based on the connection.

When identifying that an abnormality occurs in the communication network, for example, the controller 130 may identify (or monitor) whether the connection with the communication network using the communication device 110 is disconnected.

As an example, when the connection is lost, the controller 130 may attempt a connection with a sub-communication network provided by a sub-operator of the specified operator corresponding to the current position using the communication device 110 based on the operator list information. The sub-communication network may include a communication network which provides a communication connection service to an area including the current position of the host vehicle.

As an example, when the connection is not disconnected, the controller 130 may continuously perform communication using the communication device 110 based on the connection.

For example, when identifying that the host vehicle travels from a specified section to another section after being connected with the communication network, the controller 130 may continuously monitor whether a type of the connection changes.

As an example, when it is identified that the host vehicle crosses a border based on navigation information, the controller 130 may identify that the host vehicle travels from the specified section to the other section. In other words, when identifying that the host vehicle drives from an existing country to another country based on the navigation information, the controller 130 may identify that the host vehicle travels from the specified section to the other section.

For example, when identifying that a communication network connection type changes after the host vehicle travels from the specified section to the other area, the controller 130 may operate and release a specified operation mode.

As an example, when identifying that the type changes to a second type including 2nd generation (2G), while performing the connection in a first type based on at least one of 3rd generation (3G), 4th generation (4G), or 5th generation (5G), or any combination thereof, the controller 130 may operate and release the operation mode. In other words, when identifying that the communication network changes to a situation in which it is relatively poor, the controller 130 may operate and release the specified operation mode to attempt a communication network connection of good quality, which is provided from operators (or service providers) (e.g., communication companies) in a country the host vehicle newly enters.

As another example, when identifying that the communication network connection corresponds to the second type after the host vehicle travels from the specified section to the other area, the controller 130 may operate and release the operation mode. In other words, when identifying that the communication network connection is maintained in the situation in which it is relatively poor, the controller 130 may operate and release the specified operation mode to attempt a communication network connection of good quality, which is provided by the operators in the country the host vehicle quickly and newly enters.

As an example, after releasing the specified operation mode, the controller 130 may transmit update information including a communication state of the communication network in the other section to the server. The update information may include at least one of, for example, information that the existing communication network connection corresponds to the type in which it is relatively poor at a position where the host vehicle is driving or information about a new communication network connection, or any combination thereof.

For example, when receiving a signal including a specified code, after being connected with the communication network corresponding to the specified operator, the controller 130 may operate and release the specified operation mode for stopping the operation of the communication device 110.

As an example, when receiving a signal including a reject and/or detach code from the communication network, the controller 130 may disconnect the connection with the communication network and may operate the communication device 110 in the specified operation mode.

As an example, the specified operation mode may include an airplane mode. The airplane mode may be, for example, a function for blocking communication of the communication device 110 and stopping the operation.

As an example, the controller 130 may maintain the operation based on the specified operation mode during a specified time and may release the specified operation mode. The specified time may be a time predetermined by the producer and may be a time changeable by a setting.

For example, when the specified operation mode is released, the controller 130 may transmit update information including a communication state of the communication network to the server.

As an example, after the specified operation mode is released, the controller 130 may transmit the update information including the communication state of the communication network to the server which managers the operator list information.

As an example, the update information may include information that the signal including the reject and/or detach code is received from the communication network corresponding to the current position of the host vehicle. In other words, the controller 130 may transmit information that the communication state of the communication network corresponding to the current position of the host vehicle is bad to the server.

As an example, the server may update the operator list information using the received update information and may transmit the updated operator list information to the host vehicle based on a specified period.

As an example, the controller 130 may identify an operator for performing a communication network connection based on the updated operator list information.

For example, the controller 130 may receive the updated operator list information including the update information based on the specified period from the server and may store at least a portion of the received information in the memory 120.

The components of the vehicle control apparatus 100, which are shown in FIG. 1, are illustrative, and embodiments of the present disclosure are not limited thereto. For example, the vehicle control apparatus 100 may further include a sensor device (not shown).

For example, the sensor device may include at least one sensor including at least one of a camera, radio detection and ranging (RADAR), or light detection and ranging (LiDAR), or any combination thereof.

For example, the sensor device may identify information about the current position at which the host vehicle is currently driving.

For example, the sensor device may identify information that the host vehicle crosses a border. As an example, the sensor device may identify that the host vehicle enters a new country.

The above-mentioned operation of the sensor device may be performed by control of the controller 130.

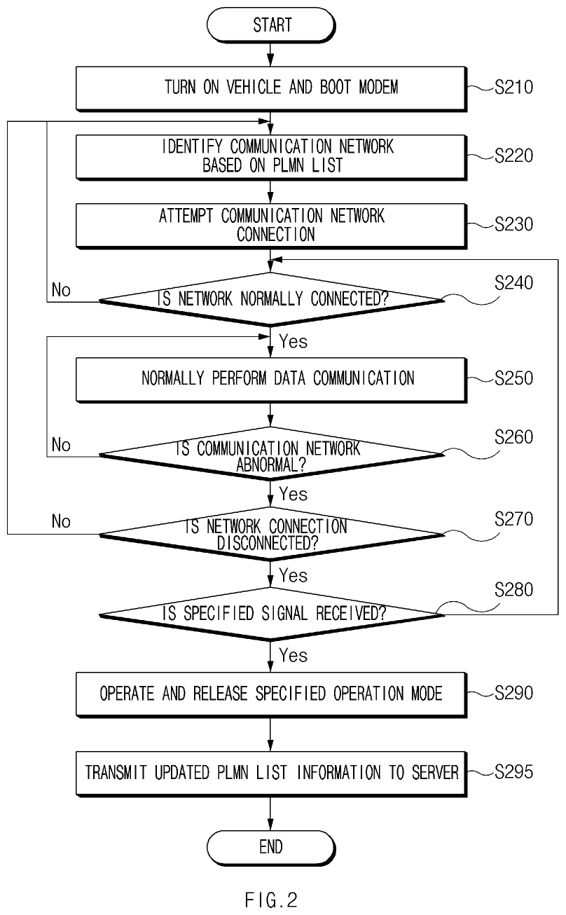

FIG. 2 is a flowchart of a communication control method for a vehicle according to an embodiment of the present disclosure.

According to an embodiment, a communication control apparatus (e.g., the vehicle control apparatus 100 of FIG. 1) may perform operations disclosed in FIG. 2. For example, at least some of the components (e.g., a communication device 110, a memory 120, and/or a controller 130 of FIG. 1) included in the vehicle control apparatus 100 may be configured to perform the operations of FIG. 2.

Operations in S210 to S295 in an embodiment below may be sequentially performed, but are not necessarily sequentially performed. For example, an order of the respective operations may be changed, and at least two operations may be performed in parallel. Furthermore, contents, which correspond to or are duplicated with the contents described above in conjunction with FIG. 2, may be briefly described or omitted.

According to an embodiment, in S210, the vehicle control apparatus may turn on a host vehicle and may boot a modem of the host vehicle.

For example, when identifying that the host vehicle is turned on, the vehicle control apparatus may boot the modem to activate a communication device including the modem.

According to an embodiment, in S220, the vehicle control apparatus may identify a communication network based on a PLMN list.

For example, the vehicle control apparatus may identify a communication network using an operator list information including the PLMN list stored in a memory to perform a communication function through the communication device.

For example, the vehicle control apparatus may identify an operator with the highest priority in response to a current position of the host vehicle and may identify a base station which provides a communication service to an area including the current position among base stations of the identified operator.

According to an embodiment, in S230, the vehicle control apparatus may attempt a communication network connection.

For example, the vehicle control apparatus may attempt a connection with the communication network provided (or served) by the base station identified in S220.

According to an embodiment, in S240, the vehicle control apparatus may identify whether a network is normally connected.

For example, the vehicle control apparatus may identify whether the communication network connection performed based on S230 is normally performed.

For example, when the network is normally connected (e.g., S240—Yes), the vehicle control apparatus may perform S250.

For example, when the network is not normally connected (e.g., S240—No), the vehicle control apparatus may repeatedly perform S220.

According to an embodiment, in S250, the vehicle control apparatus may normally perform data communication.

For example, the vehicle control apparatus may transmit and receive various types of data through communication with a communication network of the normally connected base station.

According to an embodiment, in S260, the vehicle control apparatus may monitor whether the communication network is abnormal.

For example, the vehicle control apparatus may continuously monitor whether the communication network which is being connected through the communication device to perform communication is abnormal.

For example, when an abnormality occurs in the communication network (e.g., S260—Yes), the vehicle control apparatus may perform S270.

For example, when the abnormality does not occur in the communication network (e.g., S260—Yes), the vehicle control apparatus may repeatedly perform S250.

According to an embodiment, in S270, the vehicle control apparatus may identify whether the network connection is disconnected.

For example, the vehicle control apparatus may identify whether the connection with the communication network in which the abnormality occurs is finally disconnected.

For example, when the network connection is disconnected (e.g., S270—Yes), the vehicle control apparatus may repeatedly perform S280.

For example, when the network connection is not disconnected (e.g., S270—No), the vehicle control apparatus may repeatedly perform S220.

According to an embodiment, in S280, the vehicle control apparatus may identify whether a specified signal is received.

For example, the specified signal may include a signal including a specified code (e.g., a reject code and/or a detach code).

For example, the vehicle control apparatus may identify whether the specified signal is transmitted from the base station which is performing the communication network connection.

For example, when the specified signal is received (e.g., S280—Yes), the autonomous driving control apparatus may perform S290.

For example, when the specified signal is not received (e.g., S280—No), the autonomous driving control apparatus may repeatedly perform S240.

According to an embodiment, in S280, the vehicle control apparatus may operate and release a specified operation mode.

For example, the vehicle control apparatus may temporarily operate and release the communication device in the specified operation mode (e.g., an airplane mode) to attempt another communication network connection. In other words, the vehicle control apparatus may operate the communication device during a specified time in the specified operation mode to temporarily stop the operation of the communication device and may immediately release the specified operation mode. The operation of the specified operation mode may be performed to perform a similar operation to resetting the communication device to attempt the other communication network connection.

According to an embodiment, in S295, the vehicle control apparatus may transmit updated PLMN list information to a server.

For example, the vehicle control apparatus may transmit the PLMN list information including information about a communication network connection state disclosed in the above-mentioned operations to the server.

For example, the server may update operator list information, using the PLMN list information received from the vehicle control apparatus. The server may deliver, for example, the updated operator list information to at least one vehicle including the vehicle control apparatus based on the specified period.

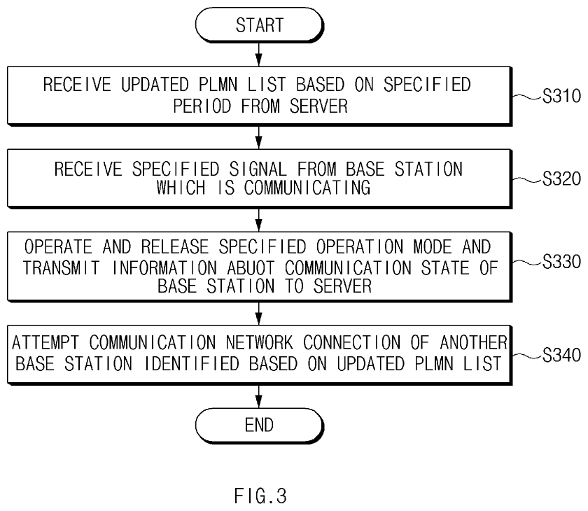

FIG. 3 is a flowchart of a vehicle control method according to an embodiment of the present disclosure.

According to an embodiment, a vehicle control apparatus (e.g., a vehicle control apparatus 100 of FIG. 1) may perform operations disclosed in FIG. 3. For example, at least some of components (e.g., a communication device 110, a memory 120, and/or a controller 130 of FIG. 1) included in the vehicle control apparatus may be configured to perform the operations of FIG. 3.

Operations in S310 to S340 in an embodiment below may be sequentially performed, but are not necessarily sequentially performed. For example, an order of the respective operations may be changed, and at least two operations may be performed in parallel. Furthermore, contents, which correspond to or are duplicated with the contents described above in conjunction with FIG. 3, may be briefly described or omitted.

For example, S310 may be an operation performed by the vehicle control apparatus after S295 of FIG. 2, which is described above, is performed.

According to an embodiment, in S310, the vehicle control apparatus may receive an updated PLMN list based on a specified period from a server.

For example, the vehicle control apparatus may receive the updated PLMN list including updated operator list information from the server.

According to an embodiment, in S320, the vehicle control apparatus may receive a specified signal from a base station which is communicating.

For example, the specified signal may include substantially the same signal as the signal received in S280 described above.

According to an embodiment, in S330, the vehicle control apparatus may operate and release a specified operation mode and may transmit information about a communication state of the base station to the server.

For example, the vehicle control apparatus may transmit the PLMN list information including the information about the communication network connection state disclosed in S320 to the server.

According to an embodiment, in S340, the vehicle control apparatus may attempt a communication network connection of another base station identified based on the updated PLMN list.

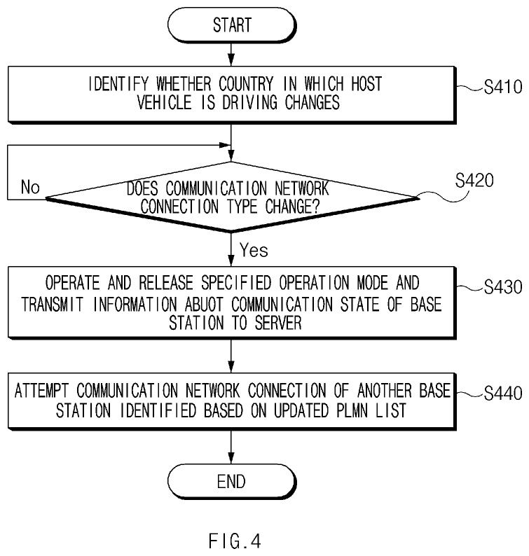

FIG. 4 is a flowchart of a vehicle control method according to an embodiment of the present disclosure.

According to an embodiment, a vehicle control apparatus (e.g., a vehicle control apparatus 100 of FIG. 1) may perform operations disclosed in FIG. 4. For example, at least some of components (e.g., a communication device 110, a memory 120, and/or a controller 130 of FIG. 1) included in the vehicle control apparatus may be configured to perform the operations of FIG. 4.

Operations in S410 to S440 in an embodiment below may be sequentially performed, but are not necessarily sequentially performed. For example, an order of the respective operations may be changed, and at least two operations may be performed in parallel. Furthermore, contents, which correspond to or are duplicated with the contents described above in conjunction with FIG. 4, may be briefly described or omitted.

According to an embodiment, in S410, the vehicle control apparatus may identify whether a country in which a host vehicle is driving changes.

For example, the vehicle control apparatus may identify whether the host vehicle crosses a border, based on navigation information. When identifying a situation in which the host vehicle performs driving in which it crosses the border, the vehicle control apparatus may identify that the country in which the host vehicle is driving changes.

According to an embodiment, in S420, the vehicle control apparatus may identify whether a communication network connection type changes.

For example, when identifying that the type changes to a second type including 2G, while performing a connection in a first type based on at least one of 3G, 4G, or 5G, or any combination thereof, the vehicle control apparatus may operate an operation mode of a communication device in a specified operation mode (e.g., an airplane mode) and release the operation mode. In other words, when identifying that the communication network connection changes to a situation in which it is relatively poor, the vehicle control apparatus may operate the communication device in the specified operation mode and may release the specified operation mode to attempt a communication network connection of good quality, which is provided from operators (or service providers) (e.g., communication companies) in a country the host vehicle enters.

As another example, when identifying that the communication network connection type corresponds to the second type in a process of changing the country in which the host vehicle is driving (or after the host vehicle travels from a specified section to another area), the vehicle control apparatus may operate and release the specified operation mode. In other words, when identifying that the communication network connection is being maintained in the situation in which it is relatively poor, the vehicle control apparatus may operate and release the specified operation mode to attempt a communication network connection of good quality, which is provided by operators in a country the host vehicle quickly and newly enters.

For example, when the communication network connection type changes (or the communication network connection type corresponds to a specified connection type (e.g., the second type)) (e.g., S420—Yes), the vehicle control apparatus may perform S430.

For example, when the communication network connection type does not change (or the communication network connection type does not correspond to the specified connection type (e.g., the second type)) (e.g., S420—No), the vehicle control apparatus may repeatedly perform S420.

According to an embodiment, in S430, the vehicle control apparatus may operate the communication device in the specified operation mode, may release the specified operation mode, and may transmit information about a communication state of the base station to a server.

For example, the vehicle control apparatus may operate the communication device in the specified operation mode and may release the specified operation mode to attempt a new communication network connection.

For example, the vehicle control apparatus may transmit information about the connection state and/or the communication state of the communication network identified in S410 and S420.

According to an embodiment, in S440, the vehicle control apparatus may attempt a communication network connection of another base station identified based on an updated PLMN list.

For example, the vehicle control apparatus may attempt a communication network connection of the other base station identified based on the updated PLMN list.

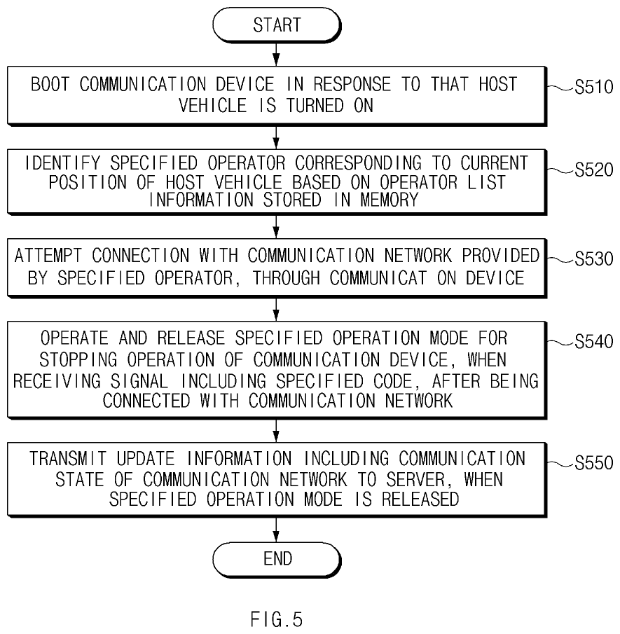

FIG. 5 is a flowchart of a vehicle control method according to an embodiment of the present disclosure.

According to an embodiment, a vehicle control apparatus (e.g., a vehicle control apparatus 100 of FIG. 1) may perform operations disclosed in FIG. 5. For example, at least some of components (e.g., a communication device 110, a memory 120, and/or a controller 130 of FIG. 1) included in the vehicle control apparatus may be configured to perform the operations of FIG. 5.

Operations in S510 to S550 in an embodiment below may be sequentially performed, but are not necessarily sequentially performed. For example, an order of the respective operations may be changed, and at least two operations may be performed in parallel. Furthermore, contents, which correspond to or are duplicated with the contents described above in conjunction with FIG. 5, may be briefly described or omitted.

According to an embodiment, in S510, the vehicle control apparatus may boot a communication device in response to that a host vehicle is turned on.

According to an embodiment, in S520, the vehicle control apparatus may identify a specified operator corresponding to a current position of the host vehicle based on operator list information stored in a memory.

According to an embodiment, in S530, the vehicle control apparatus may attempt a connection with a communication network provided by the specified operator, through a communication device.

For example, in S540, the vehicle control apparatus may operate and release the specified operation mode for stopping the operation of the communication, when receiving a signal including a specified code, after being connected with the communication network.

According to an embodiment, in S550, the vehicle control apparatus may transmit update information including a communication state of the communication network to a server, when the specified operation mode is released.

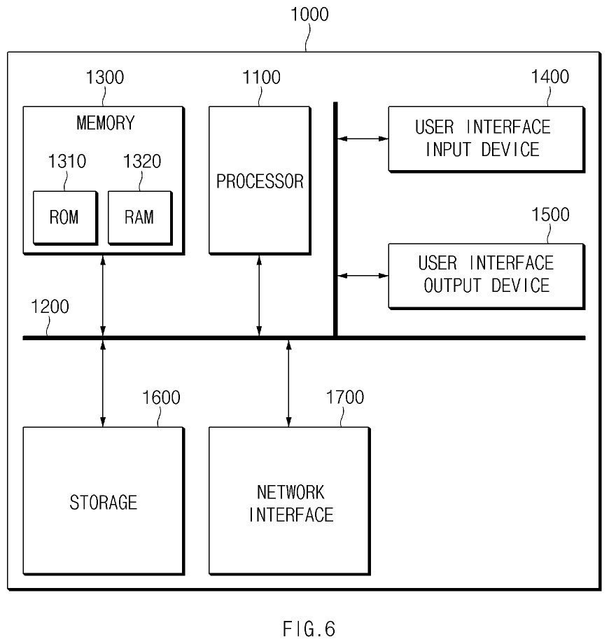

FIG. 6 illustrates a computing system about a vehicle control method according to an embodiment of the present disclosure.

Referring to FIG. 6, a computing system 1000 about the vehicle control method may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

A description will be given of effects of the vehicle control apparatus and the method thereof according to an embodiment of the present disclosure.

According to at least one of embodiments of the present disclosure, the vehicle control apparatus may attempt a connection to another communication network using a specified operation mode (e.g., an airplane mode) to shorten a required time required for a new communication network connection, when receiving a reject signal (e.g., a signal including a reject and/or detach code) through a communication network is being currently connected through a communication device.

Furthermore, according to at least one of embodiments of the present disclosure, the vehicle control apparatus may attempt a communication network connection without cold booting, thus controlling an operation of the communication device even without performing another unnecessary operation.

Furthermore, according to at least one of embodiments of the present disclosure, the vehicle control apparatus may check a communication network connection type under a driving environment in which the host vehicle crosses a border, thus quickly performing more excellent types of communication network connections.

Furthermore, according to at least one of embodiments of the present disclosure, the vehicle control apparatus may perform quickly and accurately perform a connection to another communication network even in a situation where a network electric field is not good, the host vehicle drives in an area adjacent to the border, or a communication network state is unstable, thus providing a stable communication function.

In addition, various effects ascertained directly or indirectly through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. A communication control apparatus for a vehicle, comprising:
a communication device;
a memory storing at least one instruction; and
a controller operatively connected with the communication device and the memory,
wherein the at least one instruction is configured to, when executed by the controller, cause the communication control apparatus to:
boot the communication device in response to the vehicle being turned on;
identify a specified operator corresponding to a current position of the vehicle based on operator list information stored in the memory;
attempt a connection with a communication network provided by the specified operator, through the communication device;
operate and release a specified operation mode for stopping an operation of the communication device, when receiving a signal including a specified code, after being connected with the communication network; and
transmit update information including a communication state of the communication network to a server, when the specified operation mode is released.

2. The communication control apparatus of claim 1, wherein the at least one instruction is configured to, when executed by the controller, cause the communication control apparatus to:
monitor whether the communication network is abnormal based on a connection, when normally connected with the communication network;
identify whether the connection is disconnected, when identifying that an abnormality occurs in the communication network; and
attempt a connection with a sub-communication network provided by a sub-operator of the specified operator corresponding to the current position, based on the operator list information, when the connection is lost.

3. The communication control apparatus of claim 2, wherein the at least one instruction is configured to, when executed by the controller, cause the communication control apparatus to:
continuously perform communication based on the connection, based on the connection is not lost.

4. The communication control apparatus of claim 1, wherein the specified code includes at least one of a reject code or a detach code, or any combination thereof.

5. The communication control apparatus of claim 1, wherein the at least one instruction is configured to, when executed by the controller, cause the communication control apparatus to:
continuously monitor whether a type of the connection changes, when identifying that the vehicle travels from a specified section to another section, after being connected with the communication network;
operate and release the specified operation mode, when identifying that the type changes; and
attempt a connection with a sub-communication network corresponding to the other section, the sub-communication network being provided by a sub-operator of the specified operator, based on the operator list information.

6. The communication control apparatus of claim 5, wherein the at least one instruction is configured to, when executed by the controller, cause the communication control apparatus to:
identify that the vehicle travels from the specified section to the other section, when it is identified that the vehicle crosses a border based on navigation information.

7. The communication control apparatus of claim 5, wherein the at least one instruction is configured to, when executed by the controller, cause the communication control apparatus to:
operate and release the operation mode, when identifying that the type changes to a second type including 2nd generation (2G), while performing the connection in a first type based on at least one of 3rd generation (3G), 4th generation (4G), or 5th generation (5G), or any combination thereof.

8. The communication control apparatus of claim 5, wherein the at least one instruction is configured to, when executed by the controller, cause the communication control apparatus to:
release the specified operation mode and transmit the update information including the communication state of the communication network in the other section to the server.

9. The communication control apparatus of claim 1, wherein the at least one instruction is configured to, when executed by the controller, cause the communication control apparatus to:
receive updated operator list information including the update information based on a specified period from the server and store the updated operator list information in the memory.

10. A vehicle comprising the communication control apparatus of claim 1.

11. A communication control method for a vehicle, comprising:
booting, by a controller, a communication device in response to the vehicle being turned on;
identifying, by the controller, a specified operator corresponding to a current position of the vehicle based on operator list information stored in a memory;
attempting, by the controller, a connection with a communication network provided by the specified operator, through the communication device;
operating and releasing, by the controller, a specified operation mode for stopping an operation of the communication device, when receiving a signal including a specified code, after being connected with the communication network; and
transmitting, by the controller, update information including a communication state of the communication network to a server, when the specified operation mode is released.

12. The communication control method of claim 11, further comprising:
monitoring, by the controller, whether the communication network is abnormal based on a connection, when normally connected with the communication network;
identifying whether the connection is disconnected, when identifying that an abnormality occurs in the communication network; and
attempting a connection with a sub-communication network provided by a sub-operator of the specified operator corresponding to the current position, based on the operator list information, when the connection is lost.

13. The communication control method of claim 12, further comprising:
continuously performing, by the controller, communication based on the connection, based on the connection is not lost.

14. The communication control method of claim 11, wherein the specified code includes at least one of a reject code or a detach code, or any combination thereof.

15. The communication control method of claim 11, further comprising:
continuously monitoring, by the controller, whether a type of the connection changes, when identifying that the vehicle travels from a specified section to another section, after being connected with the communication network;
operating and releasing, by the controller, the specified operation mode, when identifying that the type changes; and
attempting, by the controller a connection with a sub-communication network corresponding to the other section, the sub-communication network being provided by a sub-operator of the specified operator, based on the operator list information.

16. The communication control method of claim 15, wherein the continuous monitoring of whether the type of the connection changes, when identifying that the vehicle travels from the specified section to the other section, after being connected with the communication network, by the controller includes:
identifying, by the controller, that the vehicle travels from the specified section to the other section, when it is identified that the vehicle crosses a border based on navigation information.

17. The communication control method of claim 15, wherein the operating and releasing of the specified operation mode, when identifying that the type changes signal, by the controller includes:
operating and releasing, by the controller, the operation mode, when identifying that the type changes to a second type including 2G, while performing the connection in a first type based on at least one of 3G, 4G, or 5G, or any combination thereof.

18. The communication control method of claim 15, further comprising:
releasing, by the controller, the operation mode and transmitting, by the controller, the update information including the communication state of the communication network in the other section to the server.

19. The communication control method of claim 11, further comprising:
receiving, by the controller, updated operator list information including the update information based on a specified period from the server and storing, by the controller, the updated operator list information in the memory.

20. The communication control method of claim 11, wherein the specified operation mode includes an airplane mode.
